(19) United States
(12) Patent Application Publication
(10) Pub. No.: US 2023/0229715 A1
(43) Pub. Date: Jul. 20, 2023

(54) SEARCH METHOD AND SYSTEM BASED ON FORBIDDEN NODE AWARENESS

(71) Applicant: TSINGHUA UNIVERSITY, Beijing (CN)

(72) Inventors: Chaokun Wang, Beijing (CN); Junchao Zhu, Beijing (CN)

(21) Appl. No.: 17/844,251

(22) Filed: Jun. 20, 2022

(30) Foreign Application Priority Data
Jan. 18, 2022 (CN) 202210055745.2

(51) Int. Cl. G06F 16/953; G06F 16/908

(52) U.S. Cl. CPC G06F 16/953; G06F 16/908

(57) ABSTRACT

The disclosure proposes a search method and system based on forbidden node awareness, comprising: Get a social network consisting of multiple nodes and their interactions. Assign weights to nodes and the interaction between nodes in the social network according to the method of calculating the authority value of web pages. With the preset forbidden node sensitivity threshold, the nodes whose weights are less than the threshold are removed from the social network. The remaining nodes are arranged in descending order according to their weights. Starting from an empty community, nodes are added into the community one by one in descending order of their weights, and the corresponding weighted conductance is calculated every time the node is added. The community corresponding to the moment with the least weighted conductance is the final result of community search, which can help people find more accurate community results when there are forbidden nodes.

### TECHNICAL FIELD

The disclosure herein relates to computer science, especially to a search method and system based on forbidden node awareness.

### BACKGROUND

In computer science, biology, sociology and other fields, there exist a large number of network structures formed by nodes and the connections between nodes. In the study of network, community has received continuous attention. Community generally refers to a subgraph where intra-group connections are much denser than those inter-group ones. The community structure mined from the network helps people in many tasks such as friend recommendation, criminal gang identification and protein function prediction. Community search problem refers to the search for the community containing one or more given nodes in a network.

At present, community search methods can be divided into two kinds, including methods based on topological structures and methods based on both topological structures and node attributes. Typical topological structures include K-core and K-Truss, etc. K-core requires that the degree of each node in the community must be at least K and K-Truss requires that the number of triangles on each edge be at least K-2. Methods considering both the topological structures and node attributes usually make use of the similarity in attributes of nodes, such as AGAR. Firstly, AGAR builds a TA-graph by adding more edges according to the similarity between nodes. Then, it search the community in TA-graph based on the k-truss structure and finally get the community containing a given node. Existing approaches focus on how to define the dense structure of the community and how to deal with node attributes, without taking people's requirements on the community into account except for the given node.

In fact, existing community search methods can only find the community containing a given set of nodes, but do not allow people to restrict the nodes in the community. In many real applications, people also want to find community results that do not contain some given nodes, that is, forbidden nodes. In real life, the forbidden nodes can correspond to people in the blacklist or goods marked as unliked, etc. However, the existing methods lack support for this. Therefore, this invention aims to provide a search method based on forbidden node awareness.

### SUMMARY

To solve the above technical problems, the present disclosure proposes a search method based on forbidden node awareness, including the following steps: get a social network consisting of multiple nodes and their interactions; assign weights to nodes and the interaction between nodes in the social network according to the method of calculating the authority value of web pages; with the preset forbidden node sensitivity threshold, the nodes whose weights are less than the threshold are removed from the social network; the remaining nodes are arranged in descending order according to their weights; starting from an empty community, nodes are added into the community one by one in descending order of their weights, and the corresponding weighted conductance is calculated every time the node is added; the community corresponding to the moment with the least weighted conductance is the final result of community search.

Further, the weights assigned to nodes and the interaction between nodes in the social network according to the method of calculating the authority value of web pages represent the remoteness degree of the nodes and the interaction between nodes to preset black nodes.

Further, the step that assign weights to nodes and the interaction between nodes in the social network according to the method of calculating the authority value of web pages includes the following steps: the average probability of interaction with each adjacent node is calculated according to the number of adjacent nodes of each node; according to the nodes that must be included in the community, which are called required nodes, the closeness degrees of all nodes in the network to required nodes are obtained by the method of calculating the authority value of web pages; according to the nodes that are not allowed to appear in the community, which are called forbidden nodes, the closeness degrees of all nodes in the network to the forbidden nodes are obtained by the method of calculating the authority value of web pages; the final remoteness degree of each node to the forbidden nodes is normalized so that its value falls between 0 and 1. After setting the remoteness degree of each required node to 1 and setting the remoteness degree of each forbidden node to 0, calculate the final remoteness degree of the remaining nodes; calculate the remoteness degree between the interactions of nodes and the forbidden nodes.

Further, the step that starting from an empty community, nodes are added into the community one by one in descending order of their weights, and the corresponding weighted conductance is calculated every time the node is added includes the following steps: after ranking all nodes in the network, which represent social network users, according to their remoteness degrees to the forbidden nodes in descending order, put them into an empty community one by one; every time a node is put into the community, preserve the temporary community result and calculate its weighted conductance.

On the other hand, the present disclosure proposes a search system based on forbidden node awareness, including the following parts: first computing module, which assigns weights to nodes and the interaction between nodes in the social network according to the method of calculating the authority value of web pages; first processing module, in which with the preset forbidden node sensitivity threshold, the nodes whose weights are less than the threshold are removed from the social network; second processing module, in which the remaining nodes are arranged in descending order according to their weights; second computing module, in which starting from an empty community, nodes are added into the community one by one in descending order of their weights, and the corresponding weighted conductance is calculated every time the node is added; output module, in which the community corresponding to the moment with the least weighted conductance is the final result of community search.

Further, in first computing module, the weights assigned to nodes and the interaction between nodes in the social network according to the method of calculating the authority value of web pages represent the remoteness degree of the nodes and the interaction between nodes to preset black nodes.

Further, the first computing module includes the following parts: first computing submodule, in which the average probability of interaction with each adjacent node is calculated according to the number of adjacent nodes of each node; first acquisition submodule, where according to the nodes that must be included in the community, which are called required nodes, the closeness degrees of all nodes in the network to required nodes are obtained by the method of calculating the authority value of web pages; second acquisition submodule, where according to the nodes that are not allowed to appear in the community, which are called forbidden nodes, the closeness degrees of all nodes in the network to the forbidden nodes are obtained by the method of calculating the authority value of web pages; first processing submodule, in which the final remoteness degree of each node to the forbidden nodes is normalized so that its value falls between 0 and 1. After setting the remoteness degree of each required node to 1 and setting the remoteness degree of each forbidden node to 0, calculate the final remoteness degree of the remaining nodes; second processing submodule, which calculates the remoteness degree between the interactions of nodes and the forbidden nodes.

Further, the second computing module includes the following parts: adding submodule, in which after ranking all nodes in the network, which represent social network users, according to their remoteness degrees to the forbidden nodes in descending order, put them into an empty community one by one; second computing submodule, in which every time a node is put into the community, preserve the temporary community result and calculate its weighted conductance.

### BRIEF DESCRIPTION OF FIGURES

The accompanying drawings, which form a part of the specification, describe embodiments of the present disclosure and together with the description serve to explain the principles of the present disclosure.

The present disclosure will be more clearly understood from the following detailed description, with reference to the accompanying drawings, in which:

FIG. 1 is a flow diagram of a search method based on forbidden node awareness;

FIG. 2 is a flow diagram of assigning weights to users and their relationships in social networks based on personalized PageRank method;

FIG. 3 is a flow diagram of obtaining the closeness degrees of all users in the network to users who must be in the community by the method of personalized PageRank;

FIG. 4 is a flow diagram of obtaining the closeness degrees of all users in the network to users who are not allowed to be in the community by the method of personalized PageRank;

FIG. 5 is a flow diagram of adding nodes into an empty community one by one in descending order of their weights, and calculating the corresponding weighted conductance every time the node is added;

FIG. 6 is a schematic diagram of weighted results for users in social networks by personalized PageRank method in an embodiment of the present invention;

FIG. 7 is an experimental data diagram in an embodiment of the invention.

### DETAILED DESCRIPTION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The disclosure proposes a search method based on forbidden node awareness, including the following steps: get a social network consisting of multiple nodes and their interactions;

assign weights to nodes and the interaction between nodes in the social network according to the method of calculating the authority value of web pages; with the preset forbidden node sensitivity threshold, the nodes whose weights are less than the threshold are removed from the social network; the remaining nodes are arranged in descending order according to their weights; starting from an empty community, nodes are added into the community one by one in descending order of their weights, and the corresponding weighted conductance is calculated every time the node is added; the community corresponding to the moment with the least weighted conductance is the final result of community search.

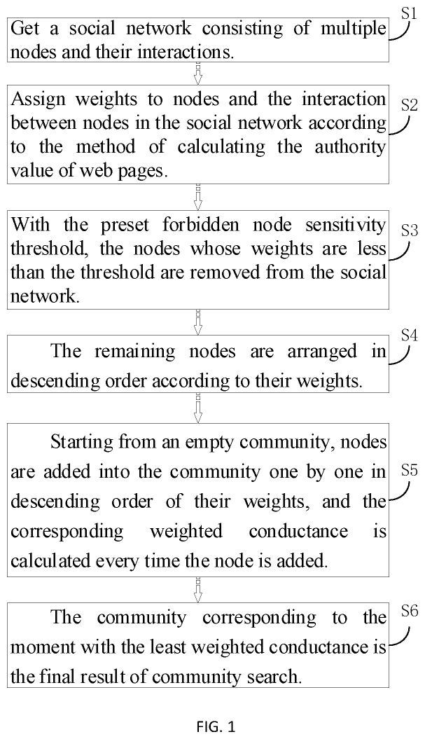

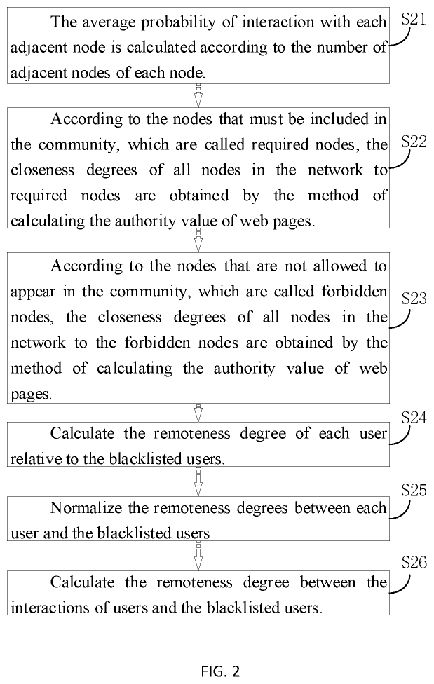

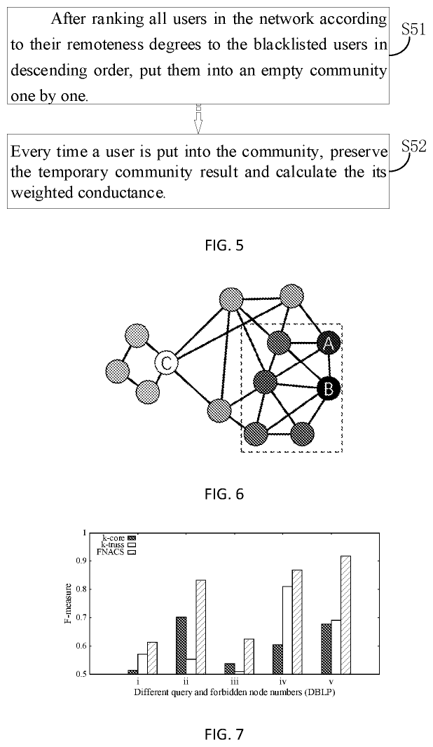

For details, see FIG. 1. A search method based on forbidden node awareness includes the following steps: S1. Construct a complex network by taking several users who are active on a certain social platform (such as Twitter, etc.) as nodes, and the interaction between users (such as likes and following, etc.) as the connections between nodes. Generally, the network can be represented by an undirected graph G=(V,E), where V represents n nodes in the graph, namely the set of users, and E represents the set of m edges in the graph, namely the set of user interactions. In addition, determine the users that must be included in the community to be searched and the blacklisted users based on real applications; S2. A variant of PageRank, a common method for calculating the authority value of web pages in the Internet, namely personalized PageRank method, is used to assign weights to users and interactions in social networks, which is used to indicate the remoteness degree of users and interactions to the preset blacklist users. The detailed process is shown in FIG. 2. FIG. 6 shows a weighted result of a social network when users A and B are the required users in the community and user C is the blacklisted user. The darker the color, the greater the weight of the node, that is, the closer it is to the required nodes, and the more distant it is from the forbidden node; S3. Using the preset forbidden node sensitivity threshold λ to remove the users whose weight is less than λ from the network, the blacklisted users who are not allowed to appear in the community and those who are close to these blacklisted users can be excluded from the network. The forbidden node sensitivity threshold λ is the preset minimum value of remoteness degree to blacklisted users, which can be adjusted according to actual needs. The value ranges from 0 to 1. The larger the threshold is, the smaller the size of the found community. Generally, the recommended threshold is 0.5; S4. The remaining users in the social network are arranged in descending order according to their weights, that is, the remoteness degrees to the blacklisted users, so as to clearly see their closeness to the required users and their distance to the blacklisted users; S5. Starting from an empty community, users are added into the community one by one in descending order of their weights, and the corresponding weighted conductance is calculated every time the user is added. The inventor believes that the cohesiveness of the community structure can be reflected by the weighted conductance and a formula is defined to calculate it. See FIG. 5 for the specific process; S6. The community corresponding to the moment with the least weighted conductance is the final result of community search. The smaller the weighted conductance is, the more cohesive the community is. Therefore, the community result at the moment of the minimum weighted conductance in S5 step is taken as the final result of community search. FIG. 7 shows the comparison of five different community search results between the proposed method (named FNACS) and different benchmark methods (K-core method and K-Truss method) on the DBLP data set (a paper collaborative network data set). It reflects that the proposed method outperforms the benchmark methods in the accuracy of community search (reflected by F-measure).

See FIG. 2. Using personalized PageRank method to assign weights to users and interactions in social networks to indicate their remoteness degree to the preset blacklist users includes the following steps: S21. According to the number of adjacent users of each user, the average probability of interaction with each adjacent user is calculated and integrated into the transition probability matrix. Its calculation formula is M=A^{T}D⁻¹, in which M is the transition probability matrix, A is the adjacency matrix corresponding to the network, D is the diagonal matrix, and its elements on the diagonal are the number of adjacent users of each user; S22. According to the users that must be included in the community, which are called required nodes, the closeness degrees of all users in the network to required nodes are obtained by personalized PageRank, denoted as a vector p_{q}; S23. According to the users that are not allowed to appear in the community, which are called forbidden nodes, the closeness degrees of all users in the network to the forbidden nodes are obtained by personalized PageRank, denoted as a vector p_{f}; S24. Calculate the remoteness degree of each user relative to the blacklisted users. The calculation formula is shown as follows, where P(v) is the final remoteness degree of a user, p_{q}(v) represents the closeness of a user to required users in S22, p_{f}(v) represents the closeness of a user to blacklisted users in S23 and V is the set of all users:

$$P ( v ) = \frac{{P}_{q} ( v )}{{max}_{u ∈ V} \{ {P}_{q} ( V ) \}} - \frac{{P}_{f} ( v )}{{max}_{u ∈ V} \{ {P}_{f} ( V ) \}} ;$$

S25. Normalize the remoteness degrees between each user and the blacklisted users, so that their value is between 0 and 1. By default, the value of users that must be included in the community is set to 1, and that of blacklisted users is set to 0. The value of remaining users are) calculated according to the following formula, denoted as W(v):

$$W ( v ) = \frac{P ( v ) - {min}_{u ∈ V} \{ P ( u ) \}}{{max}_{u ∈ V} \{ P ( u ) \} - {min}_{u ∈ V} \{ P ( u ) \}} ;$$

S26. Calculate the remoteness degree between the interactions of users and the blacklisted users. The calculation formula is shown as follows, where W(u,v) represents the remoteness degree of the interaction, u,v represent the two interacted users, degree(u) and degree(v) indicates the number of users interacting with user u and user v:

$$W ( u , v ) = \frac{W ( u )}{degree ( u )} + \frac{W ( v )}{degree ( v )} .$$

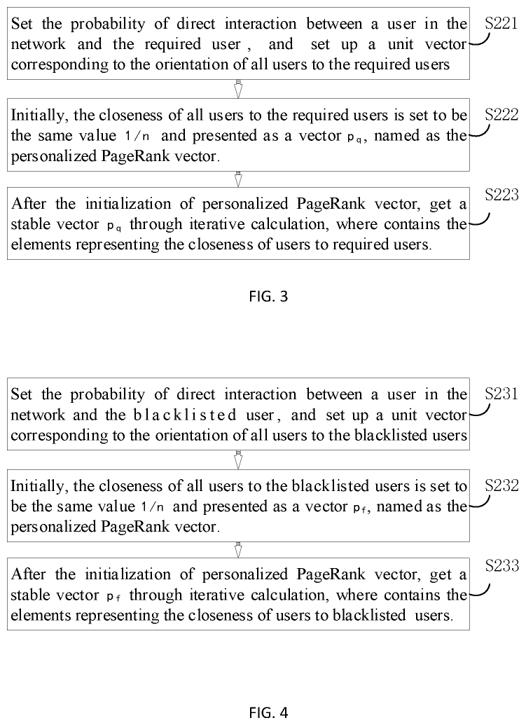

See FIG. 3. Obtaining the closeness degrees of all users in the network to required nodes by personalized PageRank, which is denoted as a vector p_{q}, includes the following steps: S221. Set the probability of direct interaction between a user in the network and the required users, which is denoted as transmission probability α and can be set to 0.15 according to experience. At the same time, set up a unit vector corresponding to the orientation of all users to the required users, where each element in the vector represent a user. Only those elements corresponding to required users are assigned to the same and non-zero positive value, other users are assigned to zero value; S222. Initially, the closeness of all users to the required users is set to be the same value 1/n and presented as a vector p_{q}, named as the personalized PageRank vector, in which n is the number of users in the network; S223. After the initialization of personalized PageRank vector, get a stable vector p_{q} through iterative calculation, where contains the elements representing the closeness of users to required users. The calculation method is to substitute the initial vector p_{q} to the right of the formula p_{q}=αv+(1−α)Mp_{q} to obtain a new one, and repeat the operation for several times until there is no change or the change is within the allowed error range. M is the transition probability matrix calculated in S21.

See FIG. 4. Obtaining the closeness degrees of all users in the network to forbidden nodes by personalized PageRank, which is denoted as a vector p_{f}, includes the following steps: S231. Set the probability of direct interaction between a user in the network and the blacklisted users, which is denoted as transmission probability α and can be set to 0.15 according to experience. At the same time, set up a unit vector corresponding to the orientation of all users to the blacklisted users, where each element in the vector represent a user. Only those elements corresponding to blacklisted users are assigned to the same and non-zero positive value, other users are assigned to zero value; S232. Initially, the closeness of all users to the blacklisted users is set to be the same value 1/n and presented as a vector p_{f}, named as the personalized PageRank vector, in which n is the number of users in the network; S233. After the initialization of personalized PageRank vector, get a stable vector p_{f} through iterative calculation, where contains the elements representing the closeness of users to required users. The calculation method is to substitute the initial vector p_{f} to the right of the formula p_{f}=αv+(1−α)Mp_{f} to obtain a new one, and repeat the operation for several times until there is no change or the change is within the allowed error range. M is the transition probability matrix calculated in S21.

See FIG. 5. The step that starting from an empty community, users are added into the community one by one in descending order of their weights, and the corresponding weighted conductance is calculated every time the user is added includes the following steps: S51. After ranking all users in the network according to their remoteness degrees to the blacklisted users in descending order, put them into an empty community one by one; S52. Every time a user is put into the community, preserve the temporary community result and calculate its weighted conductance, denoted as WC(H), which is used to represent the quality of the community. The calculation formula is shown as follows, where H is the subgraph corresponding to the community, S is the users in the community, W(u,v) is the remoteness degree of the interactions to the blacklisted users:

$$W C ( H ) = \frac{{\sum }_{u ∈ S , v ∈ V ∖ S} W ( u , v )}{2 {\sum }_{u ∈ S , v ∈ S} W ( u , v ) + {\sum }_{u ∈ S , v ∈ V ∖ S} W ( u , v )} .$$

Further, the weights assigned to nodes and the interaction between nodes in the social network according to the method of calculating the authority value of web pages represent the remoteness degree of the nodes and the interaction between nodes to preset black nodes.

Further, the step that assign weights to nodes and the interaction between nodes in the social network according to the method of calculating the authority value of web pages includes the following steps: the average probability of interaction with each adjacent node is calculated according to the number of adjacent nodes of each node; according to the nodes that must be included in the community, which are called required nodes, the closeness degrees of all nodes in the network to required nodes are obtained by the method of calculating the authority value of web pages; according to the nodes that are not allowed to appear in the community, which are called forbidden nodes, the closeness degrees of all nodes in the network to the forbidden nodes are obtained by the method of calculating the authority value of web pages; the final remoteness degree of each node to the forbidden nodes is normalized so that its value falls between 0 and 1. After setting the remoteness degree of each required node to 1 and setting the remoteness degree of each forbidden node to 0, calculate the final remoteness degree of the remaining nodes; calculate the remoteness degree between the interactions of nodes and the forbidden nodes.

Further, the step that starting from an empty community, nodes are added into the community one by one in descending order of their weights, and the corresponding weighted conductance is calculated every time the node is added includes the following steps: after ranking all nodes in the network, which represent social network users, according to their remoteness degrees to the forbidden nodes in descending order, put them into an empty community one by one; every time a node is put into the community, preserve the temporary community result and calculate its weighted conductance.

On the other hand, the present disclosure proposes a search system based on forbidden node awareness, including the following parts: acquisition module, which gets a social network consisting of multiple nodes and their interactions; first computing module, which assigns weights to nodes and the interaction between nodes in the social network according to the method of calculating the authority value of web pages.

first processing module, in which with the preset forbidden node sensitivity threshold, the nodes whose weights are less than the threshold are removed from the social network.

second processing module, in which the remaining nodes are arranged in descending order according to their weights; second computing module, in which starting from an empty community, nodes are added into the community one by one in descending order of their weights, and the corresponding weighted conductance is calculated every time the node is added; output module, in which the community corresponding to the moment with the least weighted conductance is the final result of community search.

Further, in first computing module, the weights assigned to nodes and the interaction between nodes in the social network according to the method of calculating the authority value of web pages represent the remoteness degree of the nodes and the interaction between nodes to preset black nodes.

Further, the first computing module includes the following parts: first computing submodule, in which the average probability of interaction with each adjacent node is calculated according to the number of adjacent nodes of each node; first acquisition submodule, where according to the nodes that must be included in the community, which are called required nodes, the closeness degrees of all nodes in the network to required nodes are obtained by the method of calculating the authority value of web pages; second acquisition submodule, where according to the nodes that are not allowed to appear in the community, which are called forbidden nodes, the closeness degrees of all nodes in the network to the forbidden nodes are obtained by the method of calculating the authority value of web pages; first processing submodule, in which the final remoteness degree of each node to the forbidden nodes is normalized so that its value falls between 0 and 1. After setting the remoteness degree of each required node to 1 and setting the remoteness degree of each forbidden node to 0, calculate the final remoteness degree of the remaining nodes; second processing submodule, which calculates the remoteness degree between the interactions of nodes and the forbidden nodes.

Further, the second computing module includes the following parts: adding submodule, in which after ranking all nodes in the network, which represent social network users, according to their remoteness degrees to the forbidden nodes in descending order, put them into an empty community one by one; second computing submodule, in which every time a node is put into the community, preserve the temporary community result and calculate its weighted conductance.

The disclosure introduces new requirements into the community search problem, so that users can introduce forbidden nodes in the process of community search to prevent unwanted people or things in the community results, such as blacklisted users or unliked things. The disclosure can help people find more accurate community results when there are forbidden nodes.

For those skilled in the art, Obviously, the embodiments of the present disclosure are not limited to the details of the exemplary embodiments described above, Moreover, without departing from the spirit or essential characteristics of the embodiments of the present disclosure, Embodiments of the present disclosure can thus be implemented in other specific forms, No matter from which point, The examples are to be considered exemplary, And is not limiting, The scope of embodiments of the present disclosure is defined by the appended claims rather than by the foregoing description, It is therefore intended that all changes falling within the meaning and scope of the equivalents of the claims be embraced within the embodiments of the present disclosure and that any reference numerals in the claims not be construed as limiting the claims concerned; in addition, Obviously, the word “comprising” does not exclude other elements or steps, the singular does not exclude multiple elements, modules, or devices recited in the plural system, device, or terminal claims, and the terms first, second, or the like may also be implemented by the same element, module, or device in software or hardware to denote names, rather than any particular order.

What is claimed is:

1. A search method based on forbidden node awareness, comprising:
get a social network consisting of multiple nodes and their interactions;
assign weights to nodes and the interaction between nodes in the social network according to the method of calculating the authority value of web pages;
with the preset forbidden node sensitivity threshold, the nodes whose weights are less than the threshold are removed from the social network;
the remaining nodes are arranged in descending order according to their weights;
starting from an empty community, nodes are added into the community one by one in descending order of their weights, and the corresponding weighted conductance is calculated every time the node is added;
the community corresponding to the moment with the least weighted conductance is the final result of community search.

2. The method of claim 1, wherein the weights assigned to nodes and the interaction between nodes in the social network according to the method of calculating the authority value of web pages represent the remoteness degree of the nodes and the interaction between nodes to preset black nodes.

3. The method of claim 2, wherein the step that assign weights to nodes and the interaction between nodes in the social network according to the method of calculating the authority value of web pages includes the following steps:
the average probability of interaction with each adjacent node is calculated according to the number of adjacent nodes of each node;
according to the nodes that must be included in the community, which are called required nodes, the closeness degrees of all nodes in the network to required nodes are obtained by the method of calculating the authority value of web pages;
according to the nodes that are not allowed to appear in the community, which are called forbidden nodes, the closeness degrees of all nodes in the network to the forbidden nodes are obtained by the method of calculating the authority value of web pages;
the final remoteness degree of each node to the forbidden nodes is normalized so that its value falls between 0 and 1. After setting the remoteness degree of each required node to 1 and setting the remoteness degree of each forbidden node to 0, calculate the final remoteness degree of the remaining nodes;
calculate the remoteness degree between the interactions of nodes and the forbidden nodes.

4. The method of claim 2, wherein the step that starting from an empty community, nodes are added into the community one by one in descending order of their weights, and the corresponding weighted conductance is calculated every time the node is added includes the following steps:
after ranking all nodes in the network, which represent social network users, according to their remoteness degrees to the forbidden nodes in descending order, put them into an empty community one by one;
every time a node is put into the community, preserve the temporary community result and calculate its weighted conductance.

5. A search system based on forbidden node awareness, comprising:
acquisition module, which gets a social network consisting of multiple nodes and their interactions;
first computing module, which assigns weights to nodes and the interaction between nodes in the social network according to the method of calculating the authority value of web pages;
first processing module, in which with the preset forbidden node sensitivity threshold, the nodes whose weights are less than the threshold are removed from the social network;
second processing module, in which the remaining nodes are arranged in descending order according to their weights;
second computing module, in which starting from an empty community, nodes are added into the community one by one in descending order of their weights, and the corresponding weighted conductance is calculated every time the node is added;
output module, in which the community corresponding to the moment with the least weighted conductance is the final result of community search.

6. The system of claim 5, wherein the first computing module, the weights assigned to nodes and the interaction between nodes in the social network according to the method of calculating the authority value of web pages represent the remoteness degree of the nodes and the interaction between nodes to preset black nodes.

7. The system of claim 6, wherein the first computing module includes the following parts:
first computing submodule, in which the average probability of interaction with each adjacent node is calculated according to the number of adjacent nodes of each node;
first acquisition submodule, where according to the nodes that must be included in the community, which are called required nodes, the closeness degrees of all nodes in the network to required nodes are obtained by the method of calculating the authority value of web pages;
second acquisition submodule, where according to the nodes that are not allowed to appear in the community, which are called forbidden nodes, the closeness degrees of all nodes in the network to the forbidden nodes are obtained by the method of calculating the authority value of web pages;
first processing submodule, in which the final remoteness degree of each node to the forbidden nodes is normalized so that its value falls between 0 and 1. After setting the remoteness degree of each required node to 1 and setting the remoteness degree of each forbidden node to 0, calculate the final remoteness degree of the remaining nodes;
second processing submodule, which calculates the remoteness degree between the interactions of nodes and the forbidden nodes.

8. The system of claim 5, the second computing module includes the following parts: adding submodule, in which after ranking all nodes in the network, which represent social network users, according to their remoteness degrees to the forbidden nodes in descending order, put them into an empty community one by one;
second computing submodule, in which every time a node is put into the community, preserve the temporary community result and calculate its weighted conductance.
